(19) United States
(12) Patent Application Publication
(10) Pub. No.: US 2007/0224587 A1
(43) Pub. Date: Sep. 27, 2007

(54) Allograft packaging system

(75) Inventors: James H. Forsell, San Rafael, CA (US); Ilwhan Park, Walnut Creek, CA (US)

Correspondence Address: BRUCE & MCCOY, ONE KAISER PLAZA, STE. 750, OAKLAND, CA, 94612, US

(73) Assignee: Tissue Banks International

(21) Appl. No.: 11/388,447

(22) Filed: Mar. 24, 2006

(51) Int. Cl. A01N 1/02

(52) U.S. Cl. 435/1.1; 435/284.1

(57) ABSTRACT

An allograft method and apparatus for providing and allograft package package comprised of a sponge having an internal cavity for containing an allograft and a sealable container for enclosing the sponge and maintaining the environment established at the time of closure of the sealed container.

### BACKGROUND OF THE INVENTION

1. Field of the Invention

The present invention relates to a method and apparatus for fresh, fresh frozen, and freeze dried tissue and bone allograft storage and shipping.

More particularly, it relates to an allograft musculoskeletal tissue and bone packaging and storage system which minimizes mineral loss and degradation of mechanical strength when fresh allograft is stored therein.

Still more particularly it relates to a method and apparatus for tissue and bone allograft storage and shipping which protects delicate features of fresh, fresh frozen, and freeze dried allograft from damage during handling, storing, and shipping to hospitals for utilization.

And still more particularly it relates to a method and apparatus for storage and packaging of fresh and freeze dried tissue and bone allograft which can accommodate and protect different fragile and delicate shapes thereof without mineral loss or degradation of mechanical strength when stored at room temperature.

2. Description of the Prior Art

The use of tissue and bone in one form or another for the purpose of repairing the human body is common practice. Likewise, the storage of tissue and bone allograft in anticipation of utilization is known in the prior art. However, despite the various forms of apparatus and variety of methods which have been developed for the accomplishment of the specific purpose of allograft storage, and which have been disclosed by and utilized in the prior art, the devices, apparatus, and methods which have been heretofor devised and utilized to accomplish these goals consist basically of familiar, expected, and obvious configurations, combinations, and arrangements of well known forms, methods, and apparatus. This will become apparant from the following consideration of the the closest known and relevant prior art.

The human musculoskeletal system is a network of muscles, bones, cartilages, joints, tendons, and ligaments that provide the body with the ability to perform the tasks of daily living. This system comprises a significant portion of the body and provides support, mobility, and protection for the body and its other systems. As a result, musculoskeletal disorders and diseases significantly impact a person's quality-of-life. Limitations on activity, nagging or severe pain, unsightly deformity, and the inability to function normally, have a profound effect thereon.

Orthopedics is a medical specialty that deals with the musculoskeletal system and uses medical, physical, and surgical methods to restore lost function as a result of injury or disease. In the musculoskeletal system, bone or tissue transplanted from one part of a person's body to another part is called an autograft. Whereas, bone or tissue transplanted from the body of one person to another person is called an allograft. Many people choose to donate their organs, musculoskeletal tissues, as well as other body parts upon their demise while healthy people often become donors as result of an unexpected death. Most allograft musculoskeletal tissue and bone comes from such donors, but occasionally bone allograft may come from a living patient.

Xenograft tissue and bone from bovines and porcines, defined as a graft obtained from a member of one species and transplanted to a member of another species, are processed and readily used in some special areas of orthopedic reconstruction. The term allograft, the most common form of tissue and bone transplant, as used herein also includes autograft and xenograft tissue and bone.

A tissue bank is an organization that provides donor screening, parts recovery and processing, interim storage, and distribution of tissue and bone allograft. Specialists trained in transplantation recover and process donated musculoskeletal tissues. These professionals are well-trained and most have passed a rigorous examination that certifies them on the basis of their knowledge in all areas of tissue banking including decontamination techniques, quality assurance, quality control, product testing, labeling, and recordkeeping. Each tissue bank delivers musculoskeletal tissue and bone allograft to hospitals and distributors usually by standard overnight and second day services. In order to ensure acceptable and safe arrival at the destination hospital, the tissue bank ships the allograft in three types of condition: either fresh, fresh frozen, and freeze dried condition with various packaging methods.

Freeze dried tissue and bone allograft are usually stored in either a glass or plastic container under vacuum, in a vacuum sealed pouch, or in a glass container with an airtight or vacuum seal. Although the freeze dried tissue and bone allograft do not require refrigeration, they must be rehydrated with a normal saline solution before use which is a time consuming procedure. Such a procedure is described in U.S. Pat. No. 6,739,112 B1, issued May 25, 2004, to Marino.

Fresh frozen tissue and bone allograft in comparison are continuously stored at low temperature in a glass or plastic container, a pouch, or a glass or plastic container with an airtight or vacuum seal. The fresh frozen allograft must also undergo a time consuming process to thaw the allograft before use.

Both of the freeze dried and fresh frozen allograft storage methods are proving effective and safe for storing, packaging, and delivering tissue and bone allograft to hospitals and distributors. However, such methods are very costly in terms of purchasing capital equipment such as for a freeze dryer and refrigerating equipment, time in preparation for storage, maintenance of low temperature, and reconstitution or revitalization time prior to surgeries.

It has been reported that a freeze drying process reduces the original mechanical strength of allograft. Furthermore, when a machine fabricated (modified) bone allograft is placed in a glass container, or in other containers where the allograft may freely move, and thereby bounce off of the interior wall of a rigid container during handling and shipping, some of the delicate features of the fabricated allograft may become damaged, or damage may even occur to irradiated glass or plastic containers to destroy the integrity thereof during shipping to hospitals and distributors.

Another method of the prior art for packaging and storing tissue and bone allograft relates to fresh allograft and is shown in FIG. 1. It is to place fresh allograft in a container with various normal solutions, such as distilled water, alcohol, normal saline solution, a combination of the three, or other solutions capable of maintaining a hydrated or partially hydrated state. The disadvantage with the method is that minerals are leached out of the bone allograft by the surrounding solution as shown in the illustration

The advantages of this packaging method are the elimination of refrigeration requirements, thawing procedures, or rehydration processes (a proper amount of solution keeps allograft in a hydrated state). Furthermore, fresh tissue and bone allograft can be stored and preserved at a room temperature and quickly used in an operating room by surgeons without a time consuming rehydration or thawing process. This is a great advantage when a patient is under anesthesia. Therefore, the storage and packaging of fresh allograft is of a primary consideration.

As briefly mentioned supra, the significant disadvantage in this particular prior art method of fresh allograft storage in a normal solution is the leaching of minerals from bone allograft over time, such as calcium, phosphate, and magnesium, due to the occurrence of a chemical equilibrium balancing process. It has been reported that any loss of minerals can significantly reduce the mechanical strength of the bone allograft. Consequently, a saturated solution may be enhanced to prevent leaching by adding calcium, phosphate, and magnesium minerals to the normal solution to minimize the leaching of bone minerals.

To establish a chemical equilibrium balancing solution requires precise weight and volume measurements of the bone allograft, which determines the precisely required amount of saturated solution to significantly minimize the leaching of the bone minerals. This is an additional and costly process required during packaging and for storing. Furthermore, as with prior storage processes, if the bone allograft is placed in a glass container, some delicate features of machined (modified) bone allograft may still be damaged, or damage may occur to the packaging materials during shipping and storing despite the presence of a solution in the container.

What is required is a room temperature packaging and storage system that maintains the fresh tissue and bone allograft in a constant hydrated state while significantly reducing the leaching of bone minerals during storage and shipping. Another need is for a packaging and storing system that in addition to the above provides the protection of delicate and important features of all three types of processed tissue and bone allograft from any damage due to undesirable impacts with the container during handling and shipping to destination hospitals and distributors. These are two requirements not met by the prior art methods and apparatus.

The allograft packaging system contemplated according to the present invention is useful for all three types of allograft, and it departs substantially from the conventional concepts and designs taught and used by the prior art. In doing so, it provides an apparatus and method primarily developed for the purpose of overcoming the problems as described above, but it accomplishes the results in a different and improved manner for providing safer allograft storage, and the utilization thereof more rapidly, conveniently, and economically.

### SUMMARY OF THE INVENTION

In view of the foregoing known, obvious, and described disadvantages inherent in the known and utilized types of allograft packaging and storage presently existing in the prior art, the present invention provides a new method, apparatus, and storage system for tissue and bone allograft wherein the same can be utilized to preserve, protect, store, and transport allograft.

The general purpose construction of the present invention, which will be described hereafter in greater detail, has been designed to provide a new and improved apparatus and method for the storage and shipping of bone and tissue allograft which has many of the advantages of the prior art of allograft preservation mentioned and described above. It is comprised of many novel features and advantages and performs the functions that result in a new system of allograft storage which is not anticipated, rendered obvious, suggested, or even implied by any of the prior art heretofore known, either alone or in any combination thereof.

The needs in the field of tissue and bone allograft storage are met by the present invention packaging system which includes cost-effectiveness, sterile integrity, biocompatibility, fine liquid absorbability, optimum hydration, and soft and highly cushioned mechanical properties. Furthermore, the materials can be easily handled and effortlessly fabricated in order to contain, cushion, and accommodate the various sizes and shapes of the allograft bone and tissue.

The present invention maintains fresh or redehydrated freeze dried tissue and bone allograft in a constant hydrated state at a room temperature with the use of a normal solution of a considerably smaller amount of the solution than required by the prior art which is shown in FIG. 1.

The present invention is an allograft storage and shipping package comprising a fluid absorbent sponge container having an internal cavity for containing a tissue or bone allograft, and a sealable container for enclosing the sponge container having an allograft enclosed therein and maintaining the preferred environment established internally of the sealable container at the time of closure thereof.

The more important features of the invention have been broadly outlined in the preceeding summary of the invention in order that the detailed description thereof which follows may be better understood and in order that the present contribution to an improvement in the art may be better appreciated. There are additional features of the invention that will be described hereinafter and which will form the subject matter of the claims appended hereto.

With respect to the claims hereof, and before describing at least one preferred embodiment of the invention in detail, it is to be understood that the invention is not to be limited in its application to the details of construction and to the arrangements of the components which are set forth in the following description or illustrated in the accompanying drawings. The invention is capable of being created in other embodiments and of being practiced and carried out in various ways. Also, it is to be understood that the phraseology and terminology employed here are for the purpose of description and should not be regarded as limiting.

As such, those skilled in the art in which the invention is based will appreciate that the conception upon which this disclosure is predicated may readily be utilized as a basis for the designing of other forms, structures, apparatus, systems, and methods for carrying out the several purposes of the present invention. It is important, therefore, that the claims be regarded as including such equivalent constructions in so far as they do not depart from the spirit and scope of the present invention.

Further, the purpose of the appended abstract is to enable the United States Patent and Trademark Office, and the public generally, and especially scientists, engineers and practitioners of the art who are not familiar with the patent and legal terms or phraseology, to determine quickly from cursory inspection the nature and essence of the technical disclosure of the application. The abstract is neither intended to define the invention of the specification, which is measured by the claims, nor is it intended to be limiting as to the scope of the invention in any way.

### OBJECTS OF THE INVENTION

It is therefore an important object of the present invention to provide a new and novel method and apparatus for the storage and shipping of fresh bone allograft which maintains the mechanical strength of the allograft by preventing the leaching of minerals from the allograft during storage.

It is another object of the present invention to provide a new and novel method and apparatus for storing and shipping fresh and freeze dried bone allograft at room temperature.

It is a further object of the present invention to provide a new and novel method and apparatus for the storage and shipping of fresh, machine formed, fresh frozen, and freeze dried bone allograft which protects the allograft from physical damage during handling and shipping.

It is still another object of the present invention to provide a new and novel method and apparatus for bone and tissue storage which is considerably more economical and convenient to utilize than presently employed methods of allograft storage.

It is yet a further object of the present invention to provide a new and novel method and apparatus for bone and tissue storage which requires little preparation of the allograft for storage and reduces revitalization time where required and permits immediate use of the allograft upon extraction from the storage container.

It is still another object of the present invention to provide a new and novel method and apparatus for bone and tissue storage which keeps the allograft optimally and minimally hydrated during storage and shipping

It is yet a further object of the present invention to provide a new and novel method and apparatus for bone and tissue storage which permits doctors to view the allograft in its packaging before selecting it for use and extraction from its protective enclosure.

And it is still a further object of the present invention to provide a new and novel method and apparatus for bone and tissue storage and shipping which utilizes an inexpensive, easily constructed, custom fitted shipping and storage container for tissue and bone allograft.

Other objects and advantages of the present invention will be come apparent when the method and apparatus of the present invention are considered in conjunction with the accompanying drawings.

### DESCRIPTION OF THE DRAWINGS

The invention is illustrated in the accompanying drawings but not limited by reference to the particular embodiments shown therein of which:

FIG. 1 illustrates the prior art of allograft packaging with the leaching of minerals from the allograft;

FIG. 2 is an illustration of a pair of preferred alternative embodiments of the basic concept of the present invention with sample tissue and bone allograft;

FIG. 3 is a perspective view of a preferred two piece rectangular packaging container of the present invention;

FIG. 4 is a is an exploded perspective view of an alternative two piece packaging container;

FIG. 5 is a perspective view of a preferred two piece rectangular packaging container of the present invention having a transparent cover;

FIG. 6 illustrates the placement of the preferred embodiment of FIG. 4 sealed in a pouch;

FIG. 7 illustrates the placement of the preferred embodiment of FIG. 4 in a glass container sealed in a pouch;

FIG. 8 illustrates an exploded perspective view of a preferred embodiment packaging for a ligament tissue allograft in a rectangular container of the present invention;

FIG. 9 illustrates the placement of a soaked rectangular shape container of FIG. 7 in an airtight sealed pouch; and

FIG. 10 is a cross-sectional view of the soaked cylindrical shape container of FIG. 4 of the present invention with the sponge container sealed in a glass container.

### DESCRIPTION OF THE PREFERRED EMBODIMENT

Reference is made to the drawings for a description of the preferred embodiment of the present invention wherein like reference numbers represent like elements on corresponding views.

In the procedure for allograft collection, after each donor's muscles, bones, joints, cartilages, tendons, and ligaments are recovered, screened and processed, they are aseptically prepared into three types of tissue and bone allograft prior to packaging. The three conditions of aseptically prepared allograft are: 1) fresh, 2) fresh frozen, and 3) freeze dried. The tissue and bone allograft are then placed into a fluid absorbent sponge container 11, shown in FIGS. 3-10, having an internal cavity 13, for storage and shipping.

The sponge container 11 is then treated with a procedure required for maintaining the allograft in its prepared condition of either wetted for fresh or rehydrated freeze dried allograft; or refrigerated for fresh frozen allograft; or kept dry for freeze dried allograft. Usually the allograft is kept sterile by sterilization which treatment can occur either before or after the allograft is placed in the sponge container depending in part upon the type of allograft and the preparation technique.

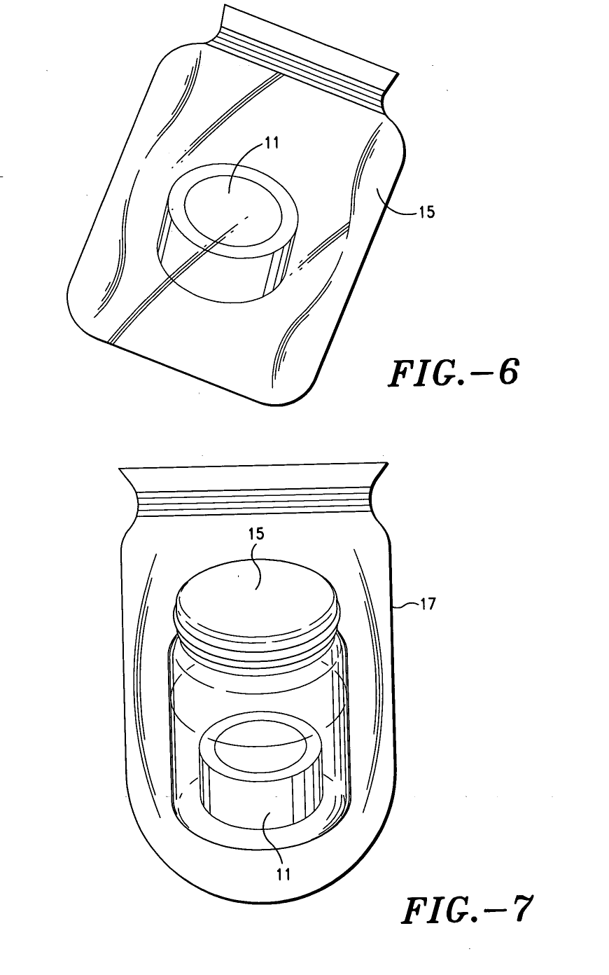

The sponge container 11 is then in turn placed in a sealable container 15, shown in FIGS. 6, 7, 9, & 10, for maintaining the preferred environment established internally of the sealable container at the time of closure thereof. The fresh, fresh frozen, and freeze dried tissue and bone allograft each require different specific environments for storage and shipping. The fresh tissue and bone allograft are normally wetted in a preservation solution and can be maintained at room temperature between 20 to 25° C. Fresh frozen allograft is maintained in that condition by refrigeration, and freeze dried allograft is kept dry and at room temperature.

The preservation solution for fresh allograft can be a normal saline solution, alcohol, distilled water, and any combination of the three, for the purpose of preservation and the prevention of dehydration by maintaining a hydrated or partially hydrated state. Optionally, the solution is used in a sterile condition and other water solutions containing chemicals such as antibiotics, preservatives, growth feeding, and cryoprotectants, etc. can be included in the solution.

Each fresh allograft is placed into the internal cavity 13 of an allograft package; the sponge container 11 of the present invention. The sponge can be cut to a preferred configuration depending upon the shape of the allograft or the container can be formed or molded out of plastic open cell foam. The term sponge as used herein encompasses any material which contains the characteristics of a sponge or plastic open cell foam which are: soft composition, easily machinable or moldable, water absorbable, and resistant to saline solution, alcohol, and natural chemicals and medicines which might be mixed into solution and used to wet the sponge to hydrate bone and tissue allograft.

The internal cavity 13 for containing the allograft partially or completely isolates and protects it from the outer environment. Optionally, the sponge container 11 is used in a sterilized condition or sterilized by autoclave, chemical sterile method, or other sterilization procedure, before use. Using forceps or any similar medical device, the sponge container containing the allograft is put into the preservation solution bath and soaked until the it absorbs enough solution or moisture to keep the allograft in a constant hydrated state. Alternatively, the solution may be added to the absorbable material of the sponge container by pipette or other solution delivery device.

The sponge container 11 is then placed into an additional package: a sealable container 15 such as a glass jar, plastic box, or flexible pouch container for maintaining the preferred environment established internally of the sealable container at the time of closure thereof. In the case of a wetted sponge, the preferred environment is a sealed in saturated atmosphere. For a sponge containing a fresh frozen allograft, the preferred environment is refrigerated. For a sponge containing a freeze dried allograft, the preferred environment is dry and evacuated.

The additional package 15 is utilized in a sterile condition or sterilized (autoclave, chemical sterile method, etc.) before use. After the sealable container additional package is closed, optionally, an airtight seal or shrink wrap can be applied under aseptic environment in order to further prevent dehydration of the solution from the sponge (if wetted) and conversely penetration by any contaminants into the container from the outer environment. Consequently, this process assures a fresh graft (or a rehydrated freeze dried allograft) to be maintained in a constant hydrated state and safe from any virus and bacteria contagion from the outer environment.

It is another option that the aseptic sealable container 15 can be placed into yet another container such as a vacuum sealed pouch 17. Finally, the entire package can be sterilized using irradiation method and shipped to destination hospitals or distributors. However, if the allografts are packaged with all the sterile packaging options, then the aseptic packaging method, leaving the tissue and bone allograft in an aseptic condition inside the sterilized containers, can be selected without the irradiation sterilization.

In the case of fresh frozen tissue and bone allograft, the packaging and storing process is similar to the one for the fresh allograft except for the fact that the sponge package does not undergo the solution soaking process. However, an additional step is required for the fresh frozen tissue and bone allograft because it must be continuously refrigerated: insulated at a low temperature with ice, dry ice, or any mechanical freezer. Also, prior to using the fresh frozen allograft, a thawing process is required usually in a room temperature normal saline solution. This is a time-consuming procedure which can be detrimental to the implementation operation timing and possibly to the allograft.

On the other hand, the packaging process of the freeze dried tissue and bone allograft is identical to the one with the fresh tissue and bone allograft except for the fact that as with fresh frozen allograft, the sponge package does not undergo the solution soaking process. However, unlike fresh allograft, a rehydration process is required before the use of the freeze dried allograft at an operating room. The rehydrated freeze dried allograft can then be stored in the same manner as for fresh allograft.

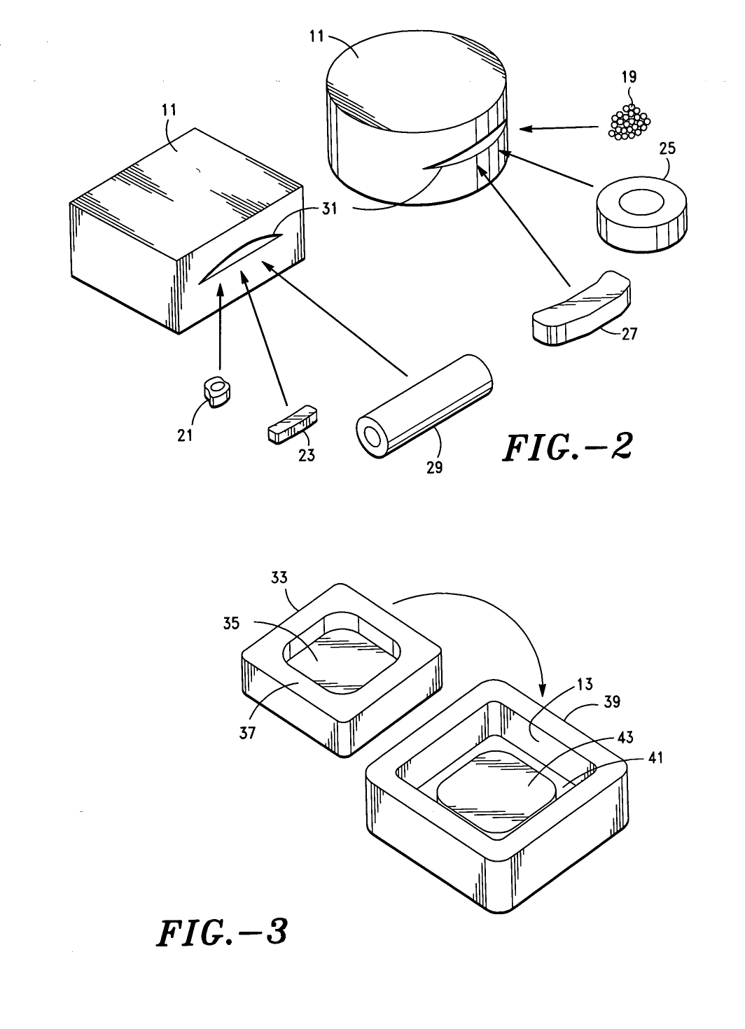

As shown in FIGS. 2, 3, & 4, the configurations of the sponge container 11 can be easily cut, fabricated, and formed into various shapes and sizes. It can be made of natural sponges, such as spheciospongia, vesparium, tethya diploderma, hippiospngia lachne, silicone sponge, newly developed oxygen sponge, polyvinyl alcohol sponge, etc. Also, the suitable foam materials include: silicone elastomers, open cell polyurethane, hydrophilic polyurethane prepolymers, and other open cell foams. These materials are: fine grained, uniform texture, biocompatible, sterilizeable, soft and highly cushioned, and especially, solution absorbable.

The rectangular and the cylindrical sponge containers is 11 of FIG. 2 with slot features are fabricated by machining or molding. An internal cavity 13 can be formed by cutting a slit into the sponge. It should be noted that other shapes may be easily fabricated to the special needs of certain allografts or to the configurations of the sealable containers the sponge containers are to the sealed in.

Furthermore, various bone allografts, such as ground (granulated) bone 19, cervical implant 21, posterior lumbar inter-body fusion implant (PLIF) 23, anterior lumbar interbody fusion implant (ALIF) 25, transforaminal lumbar inter-body fusion implant (TLIF) 27, and cortical bone shaft 29 etc. can be inserted into a slot 31 in the sponge container. It should be noted that the cervical fusion, PLIF, ALIF, and TLIF implants are precision machined fabricated units that possess many delicate and important features such as teething features (implant position stabilizing feature), gripping features, and other special characteristics which need to be protected during storage and shipping.

Therefore, the sponge container size and configuration needs to be determined, and preferably custom formed to contain the allograft configuration, to provide the full protection from outer impact and to hold enough solution to keep the fresh allograft in a constant hydrated state before use in hospitals. To prevent small allograft from accidentally departing from the container, the sponge may be provided with additional closing cover for the slots such as an adhesive tape or plastic sheet.

FIG. 3 illustrates a preferred embodiment of the invention. It is a two piece mating sponge container 11 having a double male and female interlock and provision for containing an allograft between the parts. A first piece is a sponge cover 33 that has a rectangular female pocket feature 35 for receiving a male projection from the other part. It has male downward projecting side walls 37 for engaging female receptacles in the other part 39. The female receptacles 41 which receive the side walls 37 are the depressions surrounding the male projection or central pedestal 43 of the other part. The second piece 39 is the other and lower part comprising the main body of the sponge package with a rectangular receptacle which preferably may, but may not, have an internal upward projecting pedestal configuration which fits into the internal receptacle of the first piece.

If the main sponge body 39 does not have a central pedestal 43, the sponge container 11 may only have a single male female interlock effected by the cover 33 fitting into the main body 39. In the pedestal version of the second piece 39, the pocket of the cover 35 and the pedestal 43 of the main body 39 are male and female portions which form the second male female interlock and surround and hold tissue and bone allograft between the cover 33 and the main body pedestal 43 for retaining an allograft in the cavity 13 formed between the two parts 33, 39.

Both parts 33, 39 can have male and female portions which combine to form a double male female interlock. The cover 33 is formed with an external male configuration to fit flush within the female receptacle cavity 41 formed in the main body while the internal configuration of the cover is formed with a female receptacle cavity 35 to receive the male pedestal 43 formed in the female cavity of the main body. Thus, the androgynous characteristics on both parts 33, 39 form a double male female interlock for the allograft providing maximum security against accidental separation of the parts and possible loss of the allograft as well as providing maximum cushioning to the allograft when contained between the parts.

Depending upon the application, multiple piece (more than two piece pieces) sponge or foam containers can be easily cut and fabricated to provide proper cushioning for odd shaped pieces of allograft. Furthermore, they can be custom molded in foam using various manufacturing techniques. However, the double interlock mating configuration has proven to be especially effective in cushioning allograft and maintaining a hydrated state for fresh allograft. Other simpler configurations of containers will obviously work but the interlocking design of the preferred embodiment has been found to be especially effective in protecting allograft during storage and shipping. In all two-part sponge container configurations, the two parts can be secured together by additional securement means such as tape, string, coated wire, adhesives, hook and loop fabric fasteners, and interlocking hardware, as well as innumerable others.

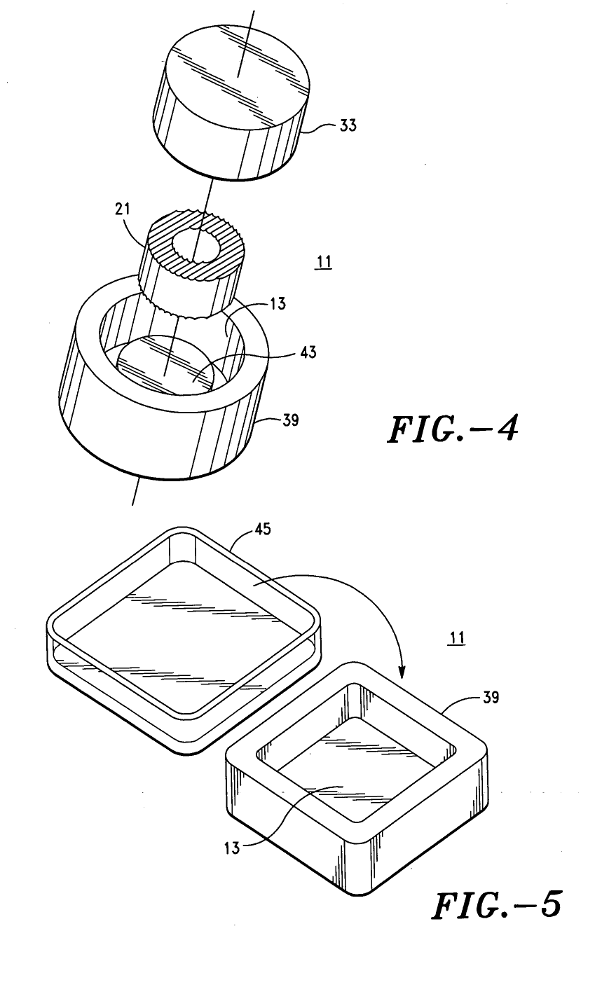

As an example, FIG. 4 shows an exploded and perspective view of an alternative embodiment of the present invention for packaging a cervical fusion implant 21. The implant is placed in pockets between the cover 33 and main body 39. The cover is provided with an internal cavity to enclose the allograft and provide a male and female double interlock. When the cover is inserted into the main body, the allograft is securely captured inside the double walled sponge container and protected and completely isolated from the outer environment.

FIG. 5 shows yet another alternative embodiment of the package. Optionally, the bone allografts can be disposed in an open cavity 13 in the sponge container 11 and at least partially covered with transparent material leaving the allograft visible for surgeons to visually inspect the quality of the allograft before they open the package for use and expose the allograft to the atmosphere or remove it from the cushioned packaging. Shown in FIG. 5 is a transparent plastic cover which fits over the main sponge body 39. Other types of and configurations of transparent cases and covers can be utilized such as a custom molded transparent sheet thermoplastic cover, made of biocompatible polycarbonate, nylon based thermoplastics, or any other material can replace the sponge or foam cover and used with the main body of the sponge container to provide not only the additional prevention of dehydration of the exposed area of the allograft while permitting a visual inspection by surgeons before use.

FIG. 6 shows the packaging of a sponge or foam container 11, soaked in a solution, in a sealable container 15. The sealable pouch container is suitable for storing soft tissue allografts; whereas, a glass or plastic (at least semi rigid) container is usually used to store and protect ground bone and bone allografts. The wetted sponge container is placed inside the pouch, and more than 95% of the air inside the pouch should be mechanically or manually removed before applying the airtight seal. Optionally, the vacuum sealed pouch can be used for fresh frozen and freeze dried allograft. On the other hand, if the sponge container is put into a glass or plastic container, an elastomer or thermoplastic based rubber lid is used to close the mouth of the container, and an airtight seal around the rubber lid is usually applied using adhesive tape, adhesive metal foil, thermoplastic shrink wrap or other ceiling materials.

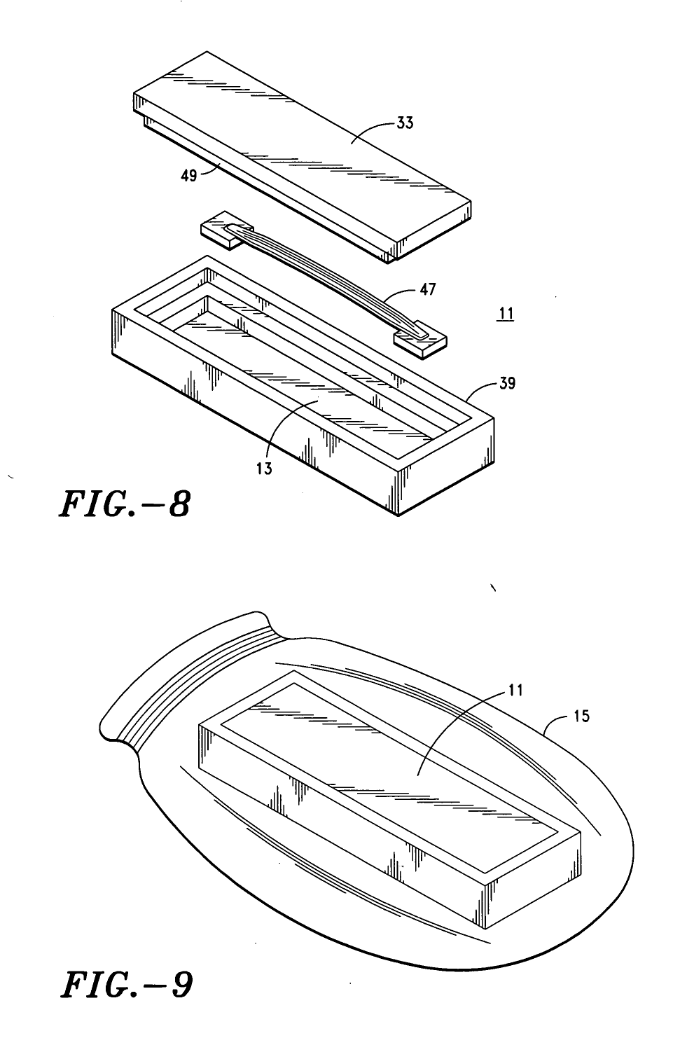

FIG. 7 illustrates still extra containment using a pouch 17 surrounding the glass or plastic container. This is an optional packaging process that further insures the isolation of the bone and tissue allograft from the outer environment. Optionally, the vacuum seal method can be applied to the enclosed bottle by mechanically removing more than at least 99% of the air inside the pouch. A flexible pouch and glass or plastic container are used interchangeably as the initial sealable containers while pouches are generally used as supplemental containers.

FIG. 8 shows still another configuration of sponge container 11 having a male female interlock. It is an exploded perspective view of the packaging for ligament tissue allograft 47. The tissue, such as patella ligament, articular cruciate ligament, posterior cruciate ligament, etc. includes the attached bones at both ends of the ligament. For sponge packaging the ligament, the packaging cover 33 and main body 39 are cut out and fabricated or custom molded. The cover 33 is provided with a lower projecting surface 49 to interlock with the bottom of the main body 39.

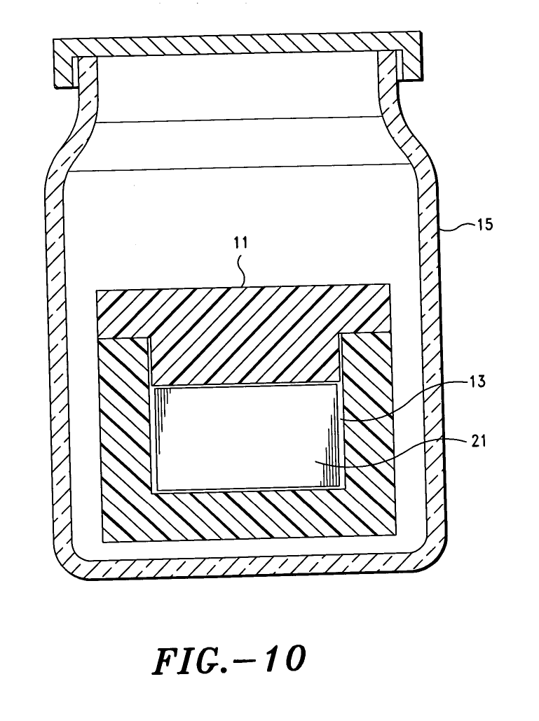

FIG. 9 displays the similar packaging method as illustrated in FIG. 6. The wetted sponge package 11 is placed into the sealable pouch. After the mechanical or manual removal of air inside the pouch, the airtight seal is applied to the opening area of the pouch. Optionally, the vacuum seal can be applied for fresh frozen and freeze dried allograft.

FIG. 10 displays the cross-sectional view of the solution soaked sponge package 11 containing a cervical implant 21 in the airtight sealed glass container 15. The package is completely isolated and protected from the outer environment by the cover and the main body of the sponge container. As in FIG. 7, the sponge package soaked in the solution in combination with the airtight seal of the glass container prevents any moisture from escaping from the bottle and keeps the allograft in a constant hydrated state over time prior to use in hospitals. The package can be stored at room temperature without leaching of minerals from the allograft.

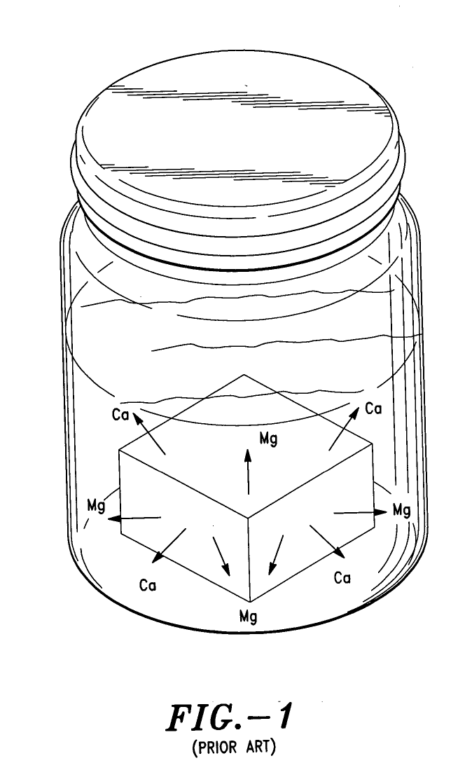

As described in the prior art of FIG. 1, when bone allograft is placed inside a glass container in a normal saline solution and closed with a rubber lid, a chemical equilibrium balancing process takes place over time, resulting in the gradual leaching of bone mineral such as calcium, magnesium, etc. The leaching of the minerals has been found to reduce the bone mechanical strength property such as compressive, tensile, and shear strength. However, the packaging method of the present invention, shown in FIG. 10, does not hold a significant amount of chemical solution around the ALIF allograft, which as a result does not create the chemical bath or environment similar to the one illustrated in FIG. 1. This combination can prevent bone minerals from leaching out or significantly minimize the leaching thereof to the surroundings while keeping the allograft adequately hydrated.

The present invention also includes the method of allograft storage and packaging which comprises the steps of first providing a fluid absorbent sponge container having a cavity formed therein for containing an allograft. The sponge is treated with a procedure required for maintaining the allograft in its prepared condition of wetted, sterile, cold, or freeze dried. The allograft is then placed into and captured in the sponge container cavity, and then the sponge container with the allograft is sealed inside a sealable container which will maintain the condition of the allograft in the sponge.

The sponge container cavity section provides intimate contact with the allograft whereby a substantial portion of the surface of said allograft is in contact with the sponge container. The sponge container is comprised of interlocking male and female portions for retaining an allograft between the sponge portions. If the allograft is fresh, or rehydrated freeze dried, the sponge is wetted end sealed in a sealable container. If the allograft is fresh frozen, the sealable container is refrigerated. If the allograft is freeze dried, it is sealed in a sealable container which is evacuated to keep the allograft dry.

The important advantage of the sponge or foam package in the present invention is the capability of the material for absorbing the storage liquid, such as distilled water, alcohol, normal saline solution, or other solutions capable of maintaining a hydrated or partially hydrated state for the tissue and bone allograft to prevent the allograft from dehydration. Furthermore, the sponge or foam package for the allograft can significantly minimize the leaching of allograft minerals since a relatively small amount of the solution is used. As a result, the original mechanical strength of the allograft can be maintained over time during storing and shipping.

Another important advantage of the present invention is that the use of soft and highly cushioned biocompatible packaging material assures the high-quality protection of tissue and bone allograft during shipping to destination hospitals or distributors. Therefore, when tissue and bone allograft are placed into and isolated by the packaging material of the present invention, the delicate and important features of tissue and bone allograft, such as multiple piece bone allografts, teething features, gripping features, and other formed surfaces can be effectively protected while shipping to hospitals and distributors.

Still another important advantage of the present invention is that it can be easily combined with other packaging methods. For fresh or rehydrated freeze dried allograft, after the packaging material is soaked in a hydration solution, the allograft is placed inside the soft sponge packaging material, and any additional package, such as glass, plastic, metal foil, pouch, and a combination of one or more of them, optionally with an airtight, vacuum seal or ship shrink wrap, can be utilized for the high-quality packaging of the tissue and bone allograft. The entire package of the allograft can then be irradiated and ready for use in a sterilized condition in hospitals without an additional rehydration or thawing process.

Thus it will be apparent from the foregoing description of the invention in its preferred form that it will fulfill all the objects and advantages attributable thereto. While it is illustrated and described in considerable detail herein, the invention is not to be limited to such details as have been set forth except as may be necessitated by the appended claims.

We claim:

1. An allograft storage and shipping package comprising
a fluid absorbent sponge container having an internal cavity for containing a tissue or bone allograft, and
a sealable container for enclosing said sponge container having an allograft enclosed therein and maintaining the preferred environment established internally of said sealable container at the time of closure thereof.

2. The allograft package of claim 1 wherein said cavity in said sponge is formed by cutting a slit into said sponge.

3. The allograft package of claim 1 wherein said sponge container is a two-part mating sponge having provision for containing an allograft between said parts.

4. The allograft package of claim 3 wherein said sponge container is comprised of male and female portions which interlock and one of which forms said cavity and the other of which forms a cover portion for retaining an allograft in said cavity.

5. The allograft package of claim 4 wherein either said male or female sponge portion is provided with a projecting surface for supporting or bearing against an allograft when one is disposed in said cavity to hold said allograft in a secured position against movement between said male and female sponge portions.

6. The allograft package of claim 5 wherein either said male or female sponge portions are provided with a double male and female interlock.

7. The allograft package of claim 1 wherein if said allograft is fresh or rehydrated freeze dried allograft, said sponge container is wetted with a preservation solution.

8. The allograft package of claim 7 where in said solution is enhanced with chemicals.

9. The allograft package of claim 1 where in said sponge container is sterilized.

10. The allograft package of claim 1 wherein said sealable container is a flexible pouch.

11. The allograft package of claim 1 wherein said sealable container is a jar.

12. The allograft package of claim 1 wherein said sealable container jar contains a preservation solution.

13. The allograft package of claim 11 wherein said sealable container is in turn sealed in a flexible pouch.

14. The allograft package of claim 13 wherein said sealable container is evacuated after it encloses a sponge container with an allograft.

15. The allograft package of claim 13 wherein said flexible pouch is evacuated after it encloses said sealable container with an allograft.

16. The allograft package of claim 1 wherein if said allograft is fresh frozen, said sealable container containing said sponge container is a flexible pouch and is refrigerated.

17. The allograft package of claim 1 wherein said cavity in said sponge container is comprised of a depression in the top surface thereof, and a transparent top cover is engaged with said sponge over said cavity for containing therein and permitting the inspection of an allograft contained therein.

21. The method of allograft storage and packaging comprising the steps of
providing a fluid absorbent sponge container having a cavity formed therein for containing an allograft,
treating said sponge with a procedure required for maintaining said allograft in its prepared condition of either wetted, sterile, refrigerated, or freeze dried,
capturing an allograft in said sponge container cavity, and
sealing said sponge container containing said allograft inside a sealable container which will maintain the prepared condition of said allograft in said sponge.

22. The method of claim in 21 wherein said sponge container formed cavity effects intimate contact with said allograft whereby a substantial portion of the surface of said allograft is in contact with said sponge container.

23. The method of claim 22 wherein said sponge container is comprised of interlocking male and female portions for retaining an allograft between said sponge portions.

24. The method of claim 23 wherein if said allograft is fresh or rehydrated freeze dried, said sponge is wetted and sealed in sealable container

25. The method of claim 23 wherein if said allograft is fresh frozen, said sealable container is refrigerated.

26. The method of claim 23 wherein if said allograft is freeze dried, it is sealed in said sealable container which is evacuated to keep said allograft dry.
